(19) United States
(12) Patent Application Publication
(10) Pub. No.: US 2008/0319574 A1
(43) Pub. Date: Dec. 25, 2008

(54) Method and device for transporting objects to distribution points

(75) Inventor: Wolf-Stephan Wilke, Konstanz (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 12/151,605

(22) Filed: May 8, 2008

(30) Foreign Application Priority Data
May 9, 2007 (DE) 10 2007 021 744.9

(51) Int. Cl. G06F 7/00; B65G 67/00

(52) U.S. Cl. 700/226; 414/809

(57) ABSTRACT

An apparatus for controlling transportation of objects provided with machine-readable codes to specified distribution points by means of a transport vehicle includes a reading device and a determination unit. The transport vehicle has a rack module for accommodating the objects, wherein the rack module has a plurality of levels. The reading device is configured to automatically read the respective code of an object transported past the reading device, and to determine the rack level on which this object is located. The determination unit processes the codes to determine which object is to be unloaded at which distribution point, and includes an evaluation unit to automatically determine for each distribution point the position of each object to be unloaded at this distribution point in the rack module depending on a sequence of the reading of the code and the rack level in which the object is located.

### CROSS-REFERENCE TO RELATED APPLICATIONS

The present application claims priority to German Patent Application No. 10 2007 021 744.9, filed on May 9, 2007, which is incorporated herein by reference.

### BACKGROUND OF THE INVENTION

The invention relates to a method for transporting objects to distribution points, and a device for controlling the transportation of objects to distribution points.

The preparation and performance of the transportation of objects to distribution points in a distribution route by means of a transport vehicle, in particular for the delivery of consignments/parcels, is at present associated with a large amount of effort. Typically, the parcels are sorted to deliverers, or a small group of deliverers by means of sorting machines and there stocked manually in transport means (for example roll cages). After transportation to a delivery depot, the parcels are manually unloaded out of the transport means again and loaded by the deliverers into the delivery vehicles appropriately for the delivery. Typically, this is performed in such a way that a certain ordering of the parcels in the delivery vehicle is established in order to facilitate access to the parcels during the delivery. However, the establishment of the ordering also means that generally it is not possible to achieve maximum packing density when loading the vehicle. Therefore, at present, a plurality of manual, laborious process steps take place one after the other.

To improve this process, DE 10136124 C1 uses mobile rack modules, which are loaded at the parcel sorting facility and then conveyed directly into the delivery vehicle and secured there. The parcels are removed during the delivery directly from the rack modules.

EP 1 298 552 B1 proposes that the code of each parcel should be read one after the other and from this, or by reading additional addresses, the destination address determined and the parcel loaded into a defined position in the rack. To avoid errors during that process, the reading is also performed by means of a hand-held reader for verification. The unloading is then performed in the distribution sequence on the distribution route using a list specifying the parcels to be unloaded at the respective distribution point and their defined positions in the rack. Hereby, the parcels are loaded manually or automatically in sequence one after the other into defined positions in the rack in the sequence of the reading of the codes. This means that it is not possible to optimize the loading with respect to the packing density.

### SUMMARY OF THE INVENTION

There is therefore a need for a method and an apparatus for transporting objects to distribution points on a distribution route by means of a delivery vehicle with rack modules for accommodating the objects provided with machine-readable codes, wherein the rack modules are loaded outside the delivery vehicle and transported into the delivery vehicle and then unloaded in the distribution sequence with which the packing density in the rack modules can be increased with as little effort as possible with the reliable identification of the objects to be unloaded.

The invention relates to a method and apparatus for transporting objects to distribution points. The objects are transported by means of a delivery vehicle with rack modules. The objects are provided with machine-readable codes. The rack modules are loaded with the objects outside the delivery vehicle and then transported in the delivery vehicle. The objects are moved relative to a reading device. Hereby, the reading device automatically reads the respective code of an object transported past the reading device, and determines the rack level in which this object is located. This information is stored in a buffer memory. For each distribution point, the position of each object to be unloaded at this distribution point is determined automatically in the rack module depending on the sequence of the reading of the code and the rack level determined in which the object is located. Then, the objects in the respective rack module to be unloaded at the corresponding distribution points are displayed.

The codes of the objects are only determined after the loading of rack modules by moving the rack modules relative to a reading device. For each rack level, the reading device has at least one separate detection device for reading the code of the respective object transported therepast. Then, the determination of the position of each object of which the code has been read takes place quickly and easily in the respective rack module depending on the sequence of the reading of the code and the respective detection device(s) which determine the code and are assigned to the respective rack level. The codes which have been read are stored with the associated position data.

In one embodiment, the at least one rack module can be moved, and the reading device is embodied as a fixed device. Further, it is advantageous for the positions of the objects to be unloaded at the corresponding distribution points to be displayed in the respective rack module.

It is particularly advantageous to record the codes in data memories which can be read in a contact-free manner, in particular RFID tags, which are located in or on the consignments. In this context, to avoid duplicate and faulty detections, the reading device comprises RFID antennas for each rack level RFID which detect RFID signals for only one object. To avoid any superimposition of the RFID signals in the RFID antennas, they can be screened against each other. In order to minimize the influence of the signals between the rack levels, it is advantageous for the rack floors to be provided with suitable screening.

To improve the identification of the objects to be unloaded by the deliverer, it is advantageous for any images taken and/or dimensions of the object determined in previous process steps to be stored electronically together with the codes assigned thereto and to be displayed with the object positions.

A further possibility for an implementation using the optically readable barcodes, customary until now, on the objects consists in the detection devices being embodied as barcode readers and the objects being aligned in the rack modules in such a way that the barcodes are facing the barcode readers.

It is also possible to take an image of the object. An image-processing method generates a feature vector for this image. This feature vector distinguishes the object from all other objects and is stored in a buffer memory. A method of this kind is known, for example, from DE 4000603 C2. In order to re-identify an object on unloading, another image is created, a feature vector generated and this new feature vector compared with all feature vectors stored in a buffer memory. The buffered feature vector which is most similar to the new vector originates from the same object.

For the purpose of simplifying the work for the deliverer, it is also advantageous for the display of the positions of the objects to be unloaded at the respective distribution point to be achieved by means of a GPS navigation module in which the distribution route is stored and which activates the display on the attainment of the respective distribution point. The display of the objects to be unloaded can be performed by means of a display device on the delivery vehicle or a portable device held by the deliverer.

With respect to the embodiment of codes, it is possible to embody them as identification (ID) codes and to determine the associated destination address data by means of a file, in which these are stored with assignment to the ID-codes. In addition, the codes can also contain the destination address data.

### BRIEF DESCRIPTION OF THE SEVERAL VIEWS OF THE DRAWINGS

The novel features and method steps characteristic of the invention are set out in the claims below. The invention itself, however, as well as other features and advantages thereof, are best understood by reference to the detailed description, which follows, when read in conjunction with the accompanying drawings, wherein:

FIG. 1 shows a schematic diagram of the loading of a delivery vehicle, and

FIG. 2 shows a schematic diagram of the unloading of a rack module in the delivery vehicle

### DETAILED DESCRIPTION OF THE INVENTION

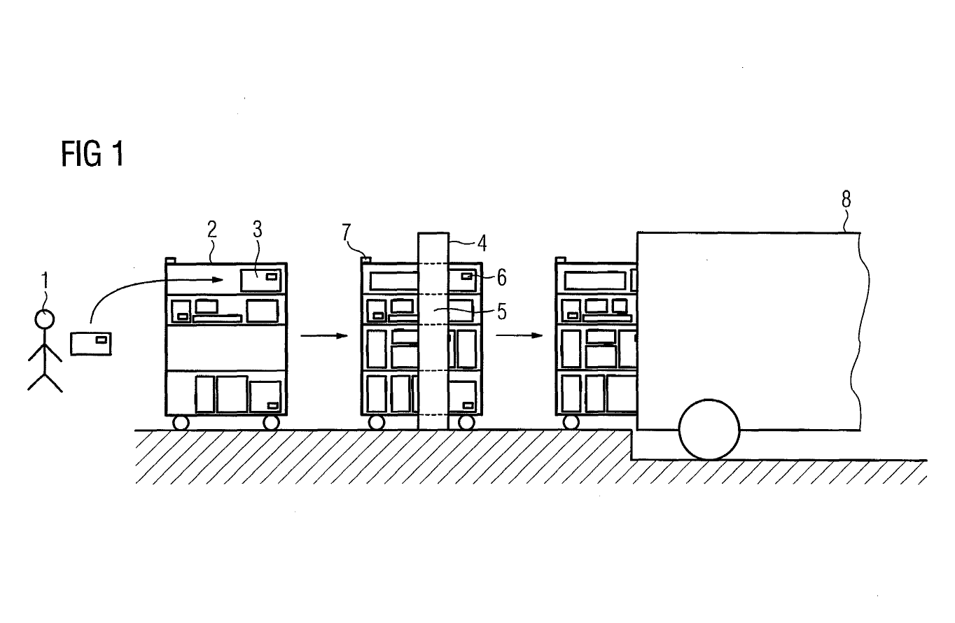

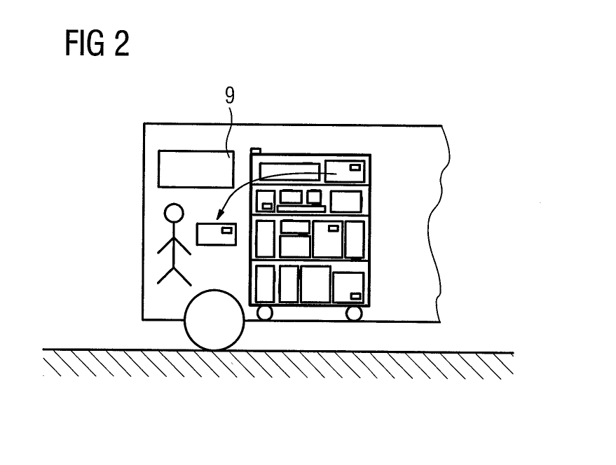

Referring to FIG. 1 and FIG. 2, a maximum packing density in the rack modules 2 can be achieved by an unsorted (that is, initially not matched to the delivery) loading of rack modules 2 with objects, in this example parcels 3 as consignments, by an operator or deliverer 1. This substantially facilitates the process since during the loading of the rack modules 2 on a parcel sorter, no previous knowledge of the delivery route with the distribution points or the parcel destinations is required.

This procedure requires the parcels to be unequivocally identifiable. This is achieved by RFID tags 6, but can also be ensured by other means such as barcodes, wherein then, however, during the loading of the rack modules 2 care must be taken to ensure the parcels are correctly aligned so that it is also possible to read the barcodes. RFID tags 6 have the advantage that the loading can also be performed without alignment as shown in the diagram.

Following the unsorted loading of the rack modules 2 with the parcels 3 for a delivery route, the rack modules 2 are individually transported past a reading device 4. The reading device 4 is embodied so that it is able to detect the parcels 3 separately according to rack levels. This takes place for example in that at least one RFID antenna 5 is attached for each level, said antenna being screened in such a way that it only detects the assigned level. The rack modules 2 are also embodied so that the screening of the levels from each other is ensured. This is performed for example in that the rack floors are made of plastic with a metallic insert. This also ensures that RFID tags 6, which are lying directly on a rack floor have a certain minimum distance to the metallic screening. This allows assigning the individual parcels 3 to a specific rack level.

Transporting the rack modules 2 past the reading device 4 enables assignment in the longitudinal rack direction. Due to the embodiment of the screening of the RFID antenna 5, the RFID tags 6 at one level are not all detected simultaneously, but successively, that is in the sequence in the longitudinal direction in which they lie in the rack module 2.

Advantageously, the reading device 4 also detects the code of the rack module 2 by reading an RFID tag 7 attached thereto.

In this way, it is possible with little effort (the degree of utilization of the installed reading device 4 is very high) to determine the position of the parcels 3 on the rack modules 2. The position data for the individual parcels 3 are, advantageously with the code of the rack module 2, transmitted together with the destination address data of individual parcels 3 to the associated delivery vehicle (transport vehicle) 8. This transmission can also take place in that the positions and destination data for the individual parcels 3 are copied to the RFID tags 7 attached to the rack module 2. This can take place at the same time as the reading process. When the rack modules 2 are inserted in the delivery vehicle 8, these data are then read out of the RFID tag 7 again on the delivery vehicle 8.

The respective distribution route with the distribution points is stored in the delivery vehicle 8, either in a navigation computer in the delivery vehicle 8 or in a portable device held by the deliverer 1. When the codes for the parcels 3 to be distributed are entered with the assigned destination addresses, the parcels 3 are then assigned to the corresponding distribution points. When a certain distribution point is attained, the deliverer 1 enters this in the navigation computer and is shown on the display the parcels 3 to be unloaded and their position in the vehicle. When a GPS device is used, the display at each distribution point is obtained automatically by the automatic establishment of the position of the delivery vehicle 8 and hence also of the distribution point.

Embodiments of the display can be, for example a graphical representation, a diagram of alphanumeric codes which are located on the rack modules 2, a visualization of the parcels 3, for example, by using the previously recorded data such as length, width and by recording an image of the surface of the parcel, or a voice output.

On the basis of the information on the display, the deliverer 1 is able to identify the parcels 3 quickly and remove them from the rack modules 2. Optionally, a reading device present on the delivery vehicle 8 can read the RFID tags 6 of the removed parcels 3 again for purposes of checking/recording.

The display of the parcels 3 to be unloaded can take place both as shown on a display device 9 attached in the delivery vehicle 8 connected to the navigation computer of the delivery vehicle 8 and also on the display of the portable device held by the deliverer 1.

To better identify the parcels 3 to be unloaded, data on the parcels 3 determined in previous process steps, such as images of the parcels 3 or their dimensions, can be displayed.

What is claimed is:

1. A method for transporting objects provided with machine-readable codes to specified distribution points by a transport vehicle having at least one rack module for accommodating the objects, wherein the rack module includes a plurality of levels, the method comprising:
loading the rack module with the objects;
automatically reading the codes;
causing the transport vehicle with the rack module to approach the distribution points;
determining via the automatically read codes which object is to be transported to which distribution point and to be unloaded there from the transport vehicle;
moving the rack module loaded with the objects relative to a reading device;
while the objects move with the rack module, automatically reading the respective code of an object passing by the reading device, and determining the rack level on which this object is located; and
automatically determining for each distribution point a position of each object to be unloaded at this distribution point depending on a sequence of the reading of the code and the determined rack level in which the object is located.

2. The method of claim 1, further comprising displaying the positions of the objects to be unloaded at the respective distribution points in the rack module.

3. The method of claim 2, further comprising:
electronically storing at least one of an image and dimensions of an object, and at least one of an assignment of the image and the dimensions to the code of this object are stored electronically; and
displaying at least one of the image and the dimensions together with the position of this object in the rack module.

4. The method of claim 1, wherein the rack module is moved relative to the reading device by transporting the rack module past the reading device.

5. The method of claim 1, wherein the reading device comprises a plurality of detection units, wherein each detection unit is assigned to a respective rack level, and wherein determining the rack level on which an object is located comprises establishing which detection unit read the code of this object.

6. The method of claim 1, wherein the codes are stored in data memories comprised by the objects, and wherein the reading device reads the codes in a contact-free manner.

7. The method of claim 6, wherein the distribution points at which the objects are be unloaded from the transport vehicle are stored in the data memories.

8. The method of claim 1, wherein for each object, the code read for this object and a specified computer-accessible assignment of this code to one of the distribution points are used for the automatic determination of the distribution point at which this object is to be unloaded.

9. The method of claim 1, wherein at the respective distribution point, at least one of the unloading and the displaying of the positions of the objects to be unloaded is activated using a GPS navigation module, in which a distribution route with the distribution points is stored.

10. The method of claims 1, wherein the objects are transported using a plurality of rack modules, wherein each rack module comprises a respective machine-readable rack module-code, wherein each rack module is moved relative to the reading device, wherein when a rack module is moved, the reading device reads the rack module-code of this rack module, and wherein for each distribution point and each object to be unloaded at the distribution point, the rack module in which this object is located is determined.

11. The method of claim 1, wherein the rack module or modules are loaded outside the delivery vehicle and then transported into the delivery vehicle.

12. An apparatus for controlling transportation of objects provided with machine-readable codes to specified distribution points by means of a transport vehicle, wherein the transport vehicle comprises at least one rack module for accommodating the objects, wherein the rack module has a plurality of levels for accommodating the objects, the apparatus comprising:
a reading device configured to automatically read the respective code of an object transported past the reading device, and to determine the rack level on which this object is located; and
a determination unit configured to process the codes to determine which object is to be unloaded at which distribution point, wherein the determination unit comprises an evaluation unit configured to automatically to determine for each distribution point a position of each object to be unloaded at this distribution point in the rack module depending on a sequence of the reading of the code and the rack level in which the object is located.

13. The apparatus of claim 12, further comprising a display device to display the positions of the objects in the rack module to be unloaded at the corresponding distribution points.

14. The apparatus of claim 13, further comprising an electronic data memory, in which at least one of an image and dimensions of at least one of the objects, and an assignment of at least one of the image and the dimensions for the code of this object are stored, wherein the display device is designed to display at least one of the image and the dimensions together with the position of this object in the rack module.

15. The apparatus of claim 12, wherein the objects are provided with data memories configured to store the codes, wherein the data memories are configured to be readable in a contact-free manner.

16. The apparatus of claim 15, wherein the data memories store for each object the distribution point at which this object is to be unloaded from the transport vehicle.

17. The apparatus of claim 12, wherein the reading device comprises a plurality of detection units, each detection unit assigned to a respective rack level, and wherein the reading device is configured to establish which detection unit read the code of this object during the determination of the rack level in which an object is located.

18. The apparatus of claim 12, wherein the determination unit is configured to have read access to a data memory, for each object, in which a computer-accessible assignment of the code of this object to one of distribution points in each case is stored, and to use the codes and the assignments to determine which object is to be unloaded at which distribution point.

19. The apparatus of claim 12, wherein the objects are transported using a plurality of rack modules, each rack module comprising a respective machine-readable rack module-code, and wherein the reading device is configured to read the rack module-code of this rack module when the objects are moved relative to the reading device, and, for each distribution point and each object to be unloaded at the distribution point, to determine the rack module in which this object is located.

20. The apparatus of claim 19, wherein each machine-readable rack module-code of a rack module is stored in a respective data memory is readable in a contact-free manner.
